(19) United States
(12) Patent Application Publication
(10) Pub. No.: US 2007/0008940 A1
(43) Pub. Date: Jan. 11, 2007

(54) Instrumentation network data system

(76) Inventor: Gideon Eden, Ann Arbor, MI (US)

Correspondence Address: James M. Deimen, Suite 300, 320 N. Main Street, Ann Arbor, MI, 48104-1192, US

(21) Appl. No.: 11/158,336

(22) Filed: Jun. 21, 2005

(51) Int. Cl. H04Q 7/24

(52) U.S. Cl. 370/338

(57) ABSTRACT

An instrumentation network data system that transmits periodically measured instrument parameters or data to work stations residing on a computer network interconnected with the instruments. A processor residing on the network periodically collects and processes data from the instruments at predetermined collection-time intervals. The processor includes a buffering data file to store the processed data. A supervision working station residing on the network periodically accesses the processed data from the buffering data file at predetermined supervision-time intervals and updates a supervision data file in the supervision working station with the processed data.

This application claims the benefit of provisional patent application No. 60/581,093 filed Jun. 17, 2004.

### BACKGROUND OF THE INVENTION

The field of the invention pertains to the networking of one or more instruments, such as scientific or text instruments, to work stations also residing on a computer network. In particular, the invention pertains to periodic sampling of instrument parameters to update parameter values on an automatic basis with manual review by a person as desired.

### SUMMARY OF THE INVENTION

The new instrumentation network data system transmits periodically measured instrument parameters or data to work stations residing on a computer network interconnected with the instruments. A processor residing on the network periodically collects and processes data from the instruments at predetermined collection-time intervals. The processor includes a buffering data file in a storage device to store the processed data. A supervision working station residing on the network periodically accesses the processed data from the buffering data file at predetermined supervision-time intervals and updates with the processed data a supervision data file located in a storage device of the supervision working station. In so doing, the supervision working station updates a status word residing in the buffering data file to acknowledge to the processor that the processed data has been reviewed by supervision means embedded in the supervision working station.

For example, the supervision means can include display means showing the processed data to a person manually operating the supervision working station to update the status word.

### DESCRIPTION OF THE PREFERRED EMBODIMENTS

The new instrumentation network data system comprises a plurality of instruments linked to a plurality of working stations. One or more computer processors residing on the network periodically collect and process data from the instruments at predetermined collection-time intervals. Each of the processors includes buffered data files in storage or memory to store processed data output from the corresponding processor at or shortly after the collection-time intervals.

Also residing on the network is at least one supervision working station periodically accessing the processed data from the buffering data files at predetermined supervision-time intervals. The supervision working stations include storage or memory for an updatable supervision data file, the storage or memory being updatable with the processed data.

More specifically, the supervision working station updates a status word residing in a buffered data file to acknowledge to the corresponding processor that the processed data has been reviewed by supervision means embedded in a supervision working station. The supervision means may include display means showing the processed data to a person manually operating a supervision working station to update the status word.

The supervision means may include a specific software program to notify a working station to update a status word after the processed data has been reviewed by the software program.

The collection-time intervals and the supervision-time intervals may be selected to be identical.

The display means may be further enhanced by display access to multiple working stations. With periodic access and presentation of the processed data from the supervision data file at predetermined viewing-time intervals, uninterrupted operation of the processors in collecting and processing data from the instruments can be effected. The collection-time intervals, supervision-time intervals and viewing-time intervals can be made identical.

The buffering data files may be sharable among the working stations. A records-locking scheme may be employed to avoid data access conflicts among the working stations sharing the buffering data files.

Similarly, the supervision data file may be sharable among the working stations on the network. A records-locking scheme may be employed to avoid data access conflicts among the working stations sharing the supervision data file.

To enable uninterrupted operation of processors collecting and processing data from the instruments, the supervision working station may indirectly access the processed data from the buffering data files by first copying the buffering data files in their entirety to the supervision data file. The access of the processed data from the supervision data file may then proceed separate from the collecting and processing of data from the instruments.

Separate alarm means can be provided for each working station to indicate alarming results obtained from a measured, collected and processed set of instrument data. The alarm means may be audible, telephonic or wireless in transmission. The system is applicable to local area networks (LAN) and wide area networks (WAN).

1. A system for transmitting periodically-measured instrument data to working stations residing on a computer network, comprising:
a processor periodically collecting and processing data from at least one instrument at predetermined collection-time intervals, wherein said processor resides on the network;
a buffering data file located in a storage device of the processor and storing processed data from the processor at the collection-time intervals;
at least one supervision working station residing on the network, periodically accessing the processed data from the buffering data file at predetermined supervision-time intervals, and updating a supervision data file located in a storage device of the supervision working station with the processed data, wherein the supervision working station updates a status word residing in the buffering data file to acknowledge to the processor that the processed data has been reviewed by supervision means embedded in the supervision working station.

2. The system of claim 1 wherein the supervision means includes display means showing the processed data to a person manually operating the working station to update the status word.

3. The system of claim 1 wherein the supervision means includes a software program that automatically notifies the working station to update the status word, after the processed data has been reviewed by the software program.

4. The system of claim 1 wherein the collection time intervals and the supervision-time intervals are identical.

5. The system of claim 1 further including at least one viewing working station residing on the network, periodically accessing and presenting the processed data from the supervision data file at predetermined viewing-time intervals, thereby enabling uninterrupted operation of the processor collecting and processing data from the instrument.

6. The system of claim 5 wherein the collection time intervals, the supervision-time intervals and the viewing time-intervals are identical.

7. The system of claim 1 wherein the buffering data file is sharable among the working stations residing on the network.

8. The system of claim 7 wherein the buffering data file employs a records-locking scheme to avoid data access conflicts between the workstations sharing the buffering data file.

9. The system of claim 1 wherein the supervision data file is sharable among the working stations residing on the network.

10. The system of claim 9 wherein the supervision data file employs a records-locking scheme to avoid data access conflicts between the workstations sharing the supervision data file.

11. The system of claim 1 wherein the supervision working station indirectly accesses the processed data from the buffering data file of the processor by first copying the buffering data file in its entirety to the supervision data file and then accessing the processed data from the supervision data file, thereby enabling uninterrupted operation of the processor collecting and processing data from the instrument.

12. The system according to claim 1 wherein at least one of the working stations includes alarm means to indicate alarming results obtained from the measured and processed instrument data.

13. The system according to claim 12 wherein the alarm means is audible.

14. The system according to claim 12 wherein the alarm means sends an alarm signal through a phone system.

15. The system according to claim 12 wherein the alarm means sends an alarm signal through a wireless device.

16. The system according to claim 1 wherein the network is a local area network (LAN).

17. The system according to claim 1 wherein the network is a wide area network (WAN).
